(19) United States
(12) Patent Application Publication
(10) Pub. No.: US 2021/0185936 A1
(43) Pub. Date: Jun. 24, 2021

(54) PLANT CULTIVATION DEVICE AND METHOD FOR CULTIVATING PLANT

(71) Applicant: SHOWA DENKO K.K., Tokyo (JP)

(72) Inventors: Fumihiko ANDO, Tokyo (JP); Yao JU, Tokyo (JP); Noriko OHTAKE, Tokyo (JP); Shinji YAMAKI, Tokyo (JP); Masaharu ISHIKURA, Tokyo (JP)

(73) Assignee: SHOWA DENKO K.K., Tokyo (JP)

(21) Appl. No.: 17/080,379

(22) Filed: Oct. 26, 2020

(30) Foreign Application Priority Data
Dec. 20, 2019 (JP) 2019-230879

(51) Int. Cl. A01G 7/04; A01G 22/15; H05B 47/155; H05B 47/16

(52) U.S. Cl. CPC A01G 7/045; A01G 22/15; A01G 31/06; H05B 47/16; H05B 47/155

(57) ABSTRACT

A plant cultivation device and the like capable of growing a plant while preventing leaves thereof from curling are provided. The device includes: a first illumination irradiating the plant to be cultivated with blue light; a second illumination irradiating the plant with red light; and a controller controlling irradiation of the blue light from the first illumination and irradiation of the red light from the second illumination, wherein the controller controls the blue light irradiation to be performed 21 hours or more a day including a case in which the blue light irradiation is performed 5 hours or more without performing the red light irradiation, and the red light irradiation to be performed 12 hours or more a day.

### CROSS REFERENCE TO RELATED APPLICATIONS

This application is based on and claims priority under 35 USC § 119 from Japanese Patent Application No. 2019-230879 filed Dec. 20, 2019.

### BACKGROUND

### Technical Field

The present invention relates to a plant cultivation device and a method for cultivating a plant.

### Related Art

In recent years, plant cultivation devices or plant cultivation methods promoting growth of plants by artificial light irradiation have been suggested.

For example, a plant cultivation apparatus described in Japanese Patent Application Laid-Open Publication No. 2015-73511 includes plural support pillars and a cultivation rack which is provided by using the support pillars and has a mounting part which mounts a cultivation vessel in which plants are planted. The cultivation rack includes a virtual cuboid-shaped cultivation region surrounded by six virtual walls and opened in both right and left sides. The plants are arranged in the cultivation region such that stems thereof are positioned above a lower virtual wall. An LED illuminating device having LED lighting fixtures is arranged in the cultivation region so as to be positioned below an upper virtual wall and above the plants. Reflection members whose reflection surfaces face inside the cultivation region are arranged on the upper virtual wall, the lower virtual wall, a front virtual wall, and a rear virtual wall of the cultivation region.

Moreover, a plant cultivation method described in International Publication No. WO 2013/021952 promotes the growth of plants by separately and independently carrying out, in fixed time periods, a step in which a red illumination light is applied to plants, and a step in which a blue illumination light is applied to the plants.

In the plants of leaf vegetables, such as lettuces, it is preferable that leaves thereof are not curled but are flat. This is because curled leaves give poor aesthetic appearance, or, for example, make it difficult to put the leaves on bread to make a sandwich.

An object of the present invention is to provide a plant cultivation device and the like capable of growing plants while preventing leaves thereof from curling.

### SUMMARY

The present invention completed under the above object provides a plant cultivation device including: a first illumination irradiating a plant to be cultivated with blue light; a second illumination irradiating the plant with red light; and a controller controlling irradiation of the blue light from the first illumination and irradiation of the red light from the second illumination, wherein the controller controls the blue light irradiation to be performed 21 hours or more a day including a case in which the blue light irradiation is performed 5 hours or more without performing the red light irradiation, and the red light irradiation to be performed 12 hours or more a day.

Here, the controller may perform the blue light irradiation 23 hours or more a day.

Moreover, the controller may perform the blue light irradiation 24 hours a day.

In addition, the plant may be a leaf lettuce not forming a head.

Moreover, the first illumination may be provided to irradiate the plant with light from above the plant.

Moreover, the plant cultivation device may further include a housing containing the first illumination, the second illumination and the plant, wherein a portion in the housing facing a region where the plant is grown may reflect the blue light and the red light.

From another standpoint, the present invention provides a method for cultivating a plant including: a step of performing blue light irradiation on a plant to be cultivated 21 hours or more a day including a case in which the blue light irradiation is performed 5 hours or more without performing red light irradiation; and a step of performing red light irradiation on the plant 12 hours or more a day.

According to the present invention, it is possible to provide a plant cultivation device and the like capable of growing plants while preventing leaves thereof from curling.

### BRIEF DESCRIPTION OF THE DRAWINGS

An exemplary embodiment of the present invention will be described in detail based on the following figures, wherein:

FIG. 1 is a diagram showing an example of a schematic configuration of a plant cultivation device related to the exemplary embodiment, which is a front elevational view of the plant cultivation device;

FIG. 2 is a cross-sectional view of the II-II portion in FIG. 1;

FIG. 3 is a diagram showing an example of a state in which a leaf is curled;

FIGS. 4A and 4B are diagrams each showing an example of periods of blue light irradiation from blue LEDs and red light irradiation from red LEDs related to the exemplary embodiment;

FIGS. 5A and 5B are diagrams each showing an example of periods of blue light irradiation from blue LEDs and red light irradiation from red LEDs related to the exemplary embodiment;

FIG. 6 is a photograph of leaves of leaf lettuces grown by use of the plant cultivation device of the exemplary embodiment;

FIG. 7 is a photograph of leaves of leaf lettuces grown by use of a plant cultivation device related to Comparative example 1;

FIG. 8 is a photograph of leaves of leaf lettuces grown by use of a plant cultivation device related to Comparative example 2; and

FIG. 9 is a diagram showing a result of comparing above-ground fresh weights.

### DETAILED DESCRIPTION

Hereinafter, an exemplary embodiment according to the present invention will be described in detail with reference to attached drawings.

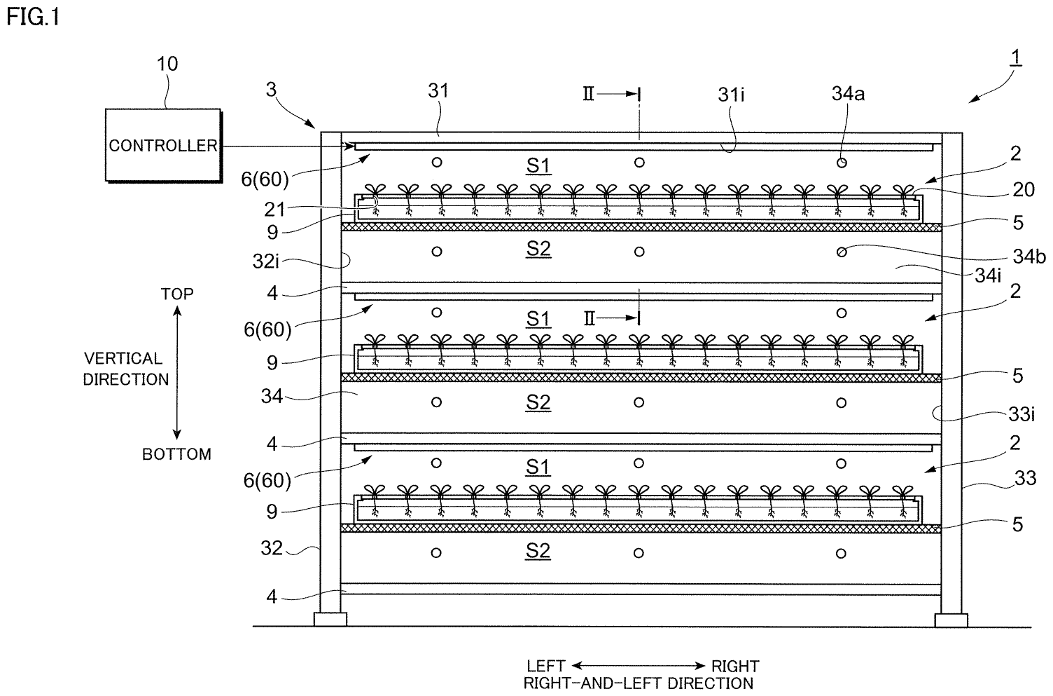

FIG. 1 is a diagram showing an example of a schematic configuration of a plant cultivation device 1 related to the exemplary embodiment, which is a front elevational view of the plant cultivation device 1. In FIG. 1, a front wall 35 of a housing 3, which will be described later, is omitted.

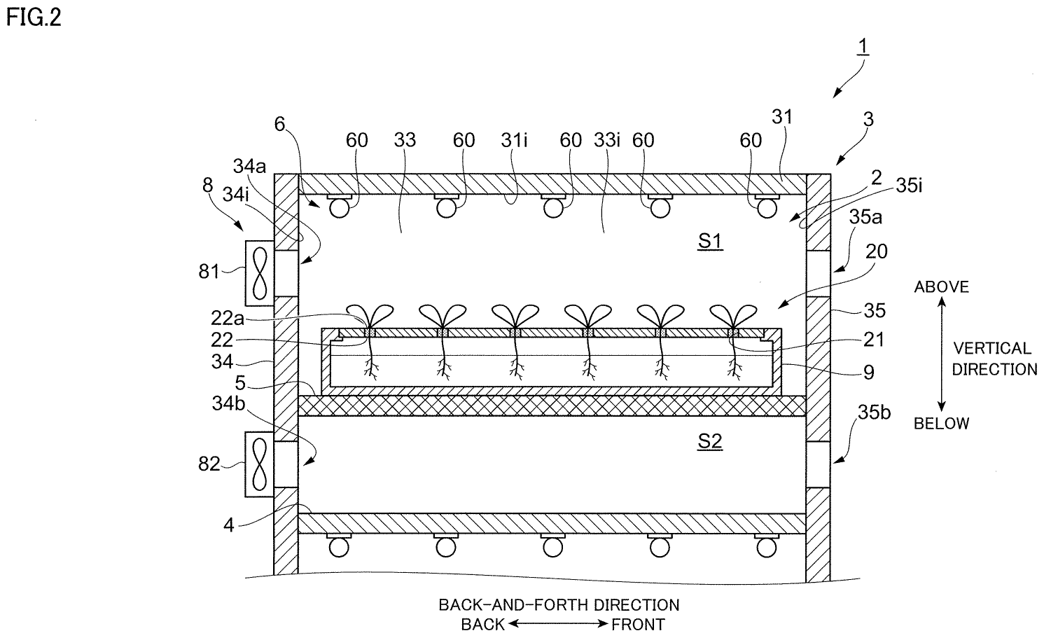

FIG. 2 is a cross-sectional view of the II-II portion in FIG. 1.

Note that, in the following description, the top and the bottom of the page in FIG. 1 are sometimes referred to as the top and the bottom of the plant cultivation device 1, respectively. Moreover, in FIG. 1, the right and the left of the page are sometimes referred to as the right and the left of the plant cultivation device 1, respectively. Further, in FIG. 1, the depth side and the front side of the page are sometimes referred to as the back and the front of the plant cultivation device 1, respectively.

The plant cultivation device 1 related to the exemplary embodiment is a device for cultivating plants. Examples of plants suitable to be cultivated by use of the plant cultivation device 1 can include leaf vegetables, such as lettuce, spinach, potherb mustard, kale, herbs, basil, wasabi (Japanese horseradish) and Indian mustard.

The plant cultivation device 1 is a so-called multistage device in which an outer shape is a rectangular-parallelepiped shape and plural (three in the example shown in FIG. 1) cultivation shelves 2 for cultivating plants are formed in the vertical direction. In the plant cultivation device 1, a pool 9 capable of storing a solution is provided to each of the cultivation shelves 2, and the plants are cultivated in a cultivation panel 20 placed on the pool 9.

The plant cultivation device 1 includes: the housing 3 collectively enclosing the plural cultivation shelves 2; base plates 4 partitioning space in the housing 3 for the plural cultivation shelves 2 and constituting bottom surfaces of the respective cultivation shelves 2; and placement parts 5 on each of which the pool 9 is placed.

Moreover, the plant cultivation device 1 includes: light irradiators 6 irradiating the plants to be cultivated in the respective placement parts 5 with light; water suppliers (not shown) supplying a nutrient solution to the pools 9; and blowers 8 for sending air currents to the respective cultivation shelves 2.

In addition, the plant cultivation device 1 includes a controller 10 controlling the function of each component of the plant cultivation device 1, such as light irradiation by the light irradiators 6, ventilation by the blowers 8, and the like.

The housing 3 includes: an upper wall 31 positioned above the cultivation shelves 2; a left wall 32 and a right wall 33 positioned on the left and right sides of the cultivation shelves 2, respectively; a rear wall 34 positioned on the rear side of the cultivation shelves 2; and a front wall 35 positioned on the front side of the cultivation shelves 2.

Though details are omitted, in the exemplary embodiment, the front wall 35 can be opened and closed with respect to the upper wall 31, the left wall 32 and the right wall 33; by opening the front wall 35, it becomes possible to carry out operations, such as setting the cultivation panels 20 to the respective cultivation shelves 2.

The upper wall 31, the left wall 32, the right wall 33, the rear wall 34 and the front wall 35 constituting the housing 3 are composed of, for example: sheets made of a synthetic resin, such as a polycarbonate resin, a polyethylene resin, a polyvinyl chloride resin, an ABS (Acrylonitrile Butadiene Styrene) resin or an acrylic resin; an aluminum plate; a steel plate the surfaces of which are coated with a resin; a synthetic resin plate on the surfaces of which a metal is deposited; or the like.

Moreover, each of an upper inner surface 31i, a left inner surface 32i, a right inner surface 33i, a rear inner surface 34i and a front inner surface 35i facing the cultivation shelves 2 in each of the upper wall 31, the left wall 32, the right wall 33, the rear wall 34 and the front wall 35, respectively, is composed of a material reflecting light emitted from the light irradiator 6. However, the material itself does not have to be the material reflecting the light; a member (for example, a plate) reflecting the light may be attached to each of the upper inner surface 31i, the left inner surface 32i, the right inner surface 33i, the rear inner surface 34i and the front inner surface 35i. Consequently, even under the environment where the sunlight does not reach, the plants can get more light.

In the rear wall 34 of the housing 3, growth-side ventilation ports 34a and lower-side ventilation ports 34b for supplying the air currents generated by the blower 8 to the cultivation shelves 2 are formed. Each growth-side ventilation port 34a is provided at a position facing a growth region S1, which will be described later, of the cultivation shelf 2. Moreover, each lower-side ventilation port 34b is provided at a position facing a lower region S2 formed between the base plate 4 and the placement part 5, which will be described later.

In this example, there are provided a total of nine growth-side ventilation ports 34a and nine lower-side ventilation ports 34b, each including three in the right-and-left direction and three in the vertical direction.

Moreover, in the front wall 35 of the housing 3, growth-side exhaust ports 35a for exhausting the air currents passed through the growth regions S1 via the growth-side ventilation ports 34a to the outside of the plant cultivation device 1 are formed. In addition, in the front wall 35 of the housing 3, lower-side exhaust ports 35b for exhausting the air currents passed through the lower regions S2 via the lower-side ventilation ports 34b to the outside of the plant cultivation device 1 are formed. Each growth-side exhaust port 35a is provided at a position facing the growth region S1 of the cultivation shelf 2. Moreover, each lower-side exhaust port 35b is provided at a position facing the lower region S2 of the cultivation shelf 2.

In this example, there are provided a total of nine growth-side exhaust ports 35a and nine lower-side exhaust ports 35b, each including three in the right-and-left direction and three in the vertical direction.

The base plates 4 partition the space enclosed by the upper wall 31, the left wall 32, the right wall 33, the rear wall 34 and the front wall 35 of the housing 3 for the plural cultivation shelves 2 and constitute the bottom surfaces of the respective cultivation shelves 2. In the example of the exemplary embodiment, three base plates 4 are provided in the vertical direction with gaps. Therefore, the plant cultivation device 1 is divided into three cultivation shelves 2 in the vertical direction by the base plates 4.

In each of the base plates 4, a drain outlet (not shown) for discharging liquids to the outside of the plant cultivation device 1 is formed. Moreover, to accelerate discharge of liquids from the drain outlet, it is preferable that the surface of the base plate 4 facing the lower region S2, which will be described later, is inclined downwardly from the side where the drain outlet is not formed (on the left side in FIG. 2, from behind the plant cultivation device 1) to the side where the drain outlet is formed (on the right side in FIG. 2, in front of the plant cultivation device 1).

The placement part 5 has a rectangular shape in a flat-plate state and is constituted by a member capable of passing liquids and gases. Each placement part 5 is constituted by a member having plural holes, such as an angle member, a wire mesh, punching metal, or the like. Note that it is preferable to constitute the placement part 5 by a material less likely to undergo deterioration, such as oxidation or dissolution, caused by the nutrient solution supplied from the water supplier.

The placement part 5 divides the space in each cultivation shelf 2 into the growth region S1 positioned above the placement part 5 where the plants are grown and the lower region S2 positioned below the placement part 5.

Each of the light irradiators 6 is provided on a surface of each of the upper wall 31 and the base plates 4, the surface facing the growth region S1 in the corresponding cultivation shelf 2, in other words, on a surface parallel to the placement part 5, to thereby irradiate the cultivation panel 20 with light necessary for growing the plants. The light irradiator 6 can be, as an example, an LED illumination that emits light by use of LEDs (Light Emitting Diodes). Each of the light irradiators 6 is in a straight tubular shape extending in the right-and-left direction, and is provided with plural (for example, five) LED lamps 60 arranged in the back-and-forth direction at predetermined regular intervals in parallel with one another.

For each LED lamp 60, blue LEDs emitting blue light, red LEDs emitting red light and white LEDs emitting white light can be used. In the LED lamp 60 of the exemplary embodiment, the plural blue LEDs emitting blue light and the plural red LEDs emitting red light are arranged in an array on a circuit board.

As the blue LEDs, for example, elements emitting light with the wavelength of 400 nm to 515 nm can be used. Moreover, as the red LEDs, for example, elements emitting light with the wavelength of 570 nm to 730 nm can be used.

Moreover, the light quantity of the blue light emitted from the blue LEDs of the LED lamp 60 can be, for example, in the range from 40 mmol/(m²·s) to 200 mmol/(m²·s) by the photosynthetic photon flux density on a cultivation surface of plants. Moreover, it can be shown as an example that the light quantity of the red light emitted from the red LEDs of the LED lamp 60 is, for example, in the range from 40 mmol/(m²·s) to 500 mmol/(m²·s) by the photosynthetic photon flux density on a cultivation surface of plants. In the case where the photosynthetic photon flux density is lower than the above range, plants are insufficiently grown in some cases. Moreover, in the case where the photosynthetic photon flux density is higher than the above range, though the growth of the plants is not affected, energy consumption is apt to increase. Note that, in the description of the exemplary embodiment, the cultivation surface of a plant means a top surface of urethane 22 charged in the through holes 21 in the cultivation panel 20 (indicated by the reference sign 22a in FIG. 2), and a sensor is placed on the cultivation surface to measure the light quantity.

The blower 8 includes plural growth-side fans 81 attached to the respective growth-side ventilation ports 34a and rotated to send the air currents to the growth regions S1 of the respective cultivation shelves 2. Moreover, the blower 8 includes plural lower-side fans 82 attached to the respective lower-side ventilation ports 34b and rotated to send the air currents to the lower regions S2 of the respective cultivation shelves 2.

The blower 8 rotates the growth-side fans 81 and the lower-side fans 82 at a predetermined time to send air to the growth regions S1 and the lower regions S2 of the respective cultivation shelves 2.

The blower 8 rotates the growth-side fans 81 to send air to the growth regions S1 during the period in which the plants are cultivated in the plant cultivation device 1 or during a predetermined period within the period in which the plants are cultivated in the plant cultivation device 1. This generates air currents in the growth regions S1 and thereby water attached to undersides of leaves of the plants grown in the growth regions S1 is likely to be evaporated; accordingly, photosynthesis of the plants can be promoted.

In addition, after the supply of the nutrient solution to the pool 9 by the water supplier is finished, the blower 8 rotates the lower-side fans 82 to send air to the lower regions S2 for a certain amount of time. This generates air currents in the lower regions S2, and thereby surfaces of the base plates 4, placement parts 5, cultivation panels 20 and the like are dried.

The controller 10 includes: a CPU (Central Processing Unit) (not shown); a RAM (Random Access Memory) (not shown) used as a working memory of the CPU; and a ROM (Read Only Memory) (not shown) storing various kinds of programs to be executed by the CPU. As shown in FIG. 1, the controller 10 may be provided outside of the housing 3 or inside of the housing 3.

The controller 10 controls ventilation by the blower 8. Moreover, the controller 10 controls light irradiation by the light irradiator 6. This will be described in detail later.

Next, a configuration of the cultivation panel 20 will be described. The cultivation panel 20 has, as viewed from above, plural through holes 21 formed in a grid pattern. For example, the cultivation panel 20 has 17 through holes 21 in the right-and-left direction and 6 through holes 21 in the back-and-forth direction, a total of 102 through holes 21.

Note that, the number of through holes 21 in the cultivation panel 20 is normally few dozen to several hundreds though the number differs depending on species of plants to be cultivated, growing conditions of plants, and so on.

Subsequently, a description will be given of a method for cultivating a plant by use of the plant cultivation device 1 of the exemplary embodiment. Here, a description will be given by taking a method for cultivating a lettuce by use of the plant cultivation device 1 as an example.

In the case where the lettuce is to be cultivated by use of the plant cultivation device 1, first, a seed of the lettuce is sown in a dent of each urethane 22, and then the sown seeds are contained in a not-shown germination promotion chamber in which an environment is adjusted to have a predetermined temperature and humidity (for example, 28° C. and RH 80%). Thereafter, when the seed slightly germinates, the urethane 22 is transferred into the through hole 21 formed in the cultivation panel 20 provided to the cultivation shelf 2 of the plant cultivation device 1.

In the case of the seed of the lettuce, the seed slightly germinates in about 48 hours (two days). In the case of the lettuce, “a seed slightly germinates” means, for example, a state in which a bud (cotyledons) can be visually recognized on the urethane 22.

### (Operations of Controller 10)

After the urethane 22 is transferred to the plant cultivation device 1, the controller 10 performs light irradiation by the light irradiators 6, supply of the nutrient solution by the water supplier, and ventilation by the blower 8 under predetermined conditions.

For example, the controller 10 controls blue light irradiation from the blue LEDs and red light irradiation from the red LEDs of the LED lamp 60 as will be described below.

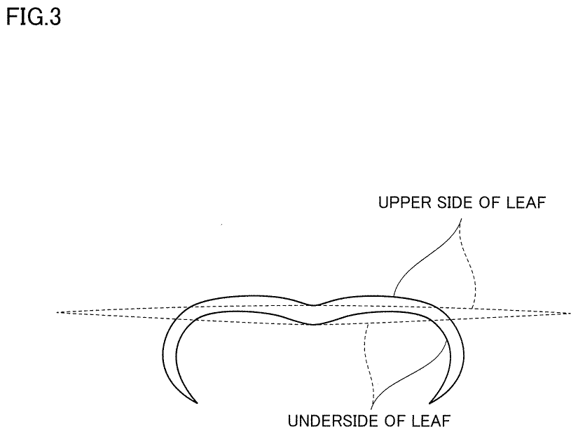

FIG. 3 is a diagram showing an example of a state in which a leaf is curled.

By the earnest study by the inventors of the present invention, it was found that, in growing plants of leaf vegetables, such as the lettuces, leaves were curled as shown in FIG. 3 due to short irradiation time of blue light from the blue LEDs. This is considered because, since the plants absorb the blue light from the blue LEDs by upper sides of leaves, the leaves determine shortage of light when the upper sides of the leaves get insufficient blue light, and therefore, cells on the upper sides of the leaves grow faster than the cells on the undersides of the leaves so as to absorb not only the light from above but also the light coming from the lateral direction caused by scattering or the like. In particular, this is considered because, as the plant cultivation device 1, in the case of a device cultivating the lettuces in such a close planting state that the leaves of the adjacent lettuces touch each other in an environment with no sunlight, the leaves get insufficient blue light.

Then, the curled leaves give poor aesthetic appearance, or, for example, make it difficult to put the leaves on bread to make a sandwich; therefore, there is a possibility that the lettuces cannot be sold and are discarded after cultivation.

In view of the above matters, the present invention provides a first period in which the blue light irradiation from the blue LEDs is performed 21 hours or more a day. Moreover, a second period in which the red light irradiation from the red LEDs is performed is provided 12 hours or more a day. Then, a third period in which the blue light irradiation is performed while the red light irradiation is not performed is provided 5 hours or more a day. In other words, the controller 10 controls the blue light irradiation from the blue LEDs and the red light irradiation from the red LEDs to carry out the blue light irradiation 21 hours or more a day and the red light irradiation 12 hours or more a day including the case in which the blue light irradiation is performed 5 hours or more without performing the red light irradiation.

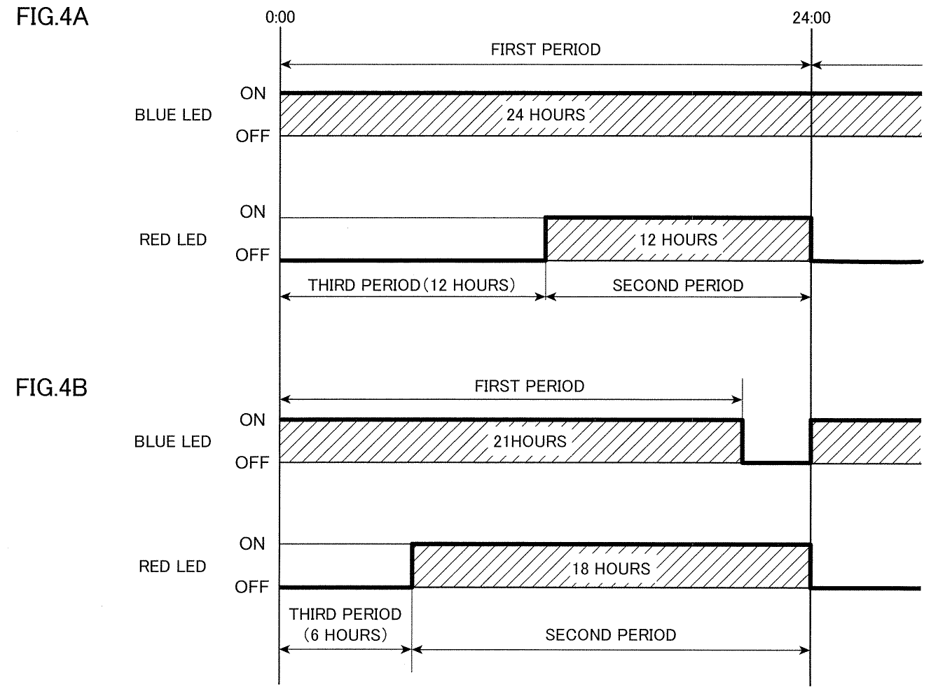

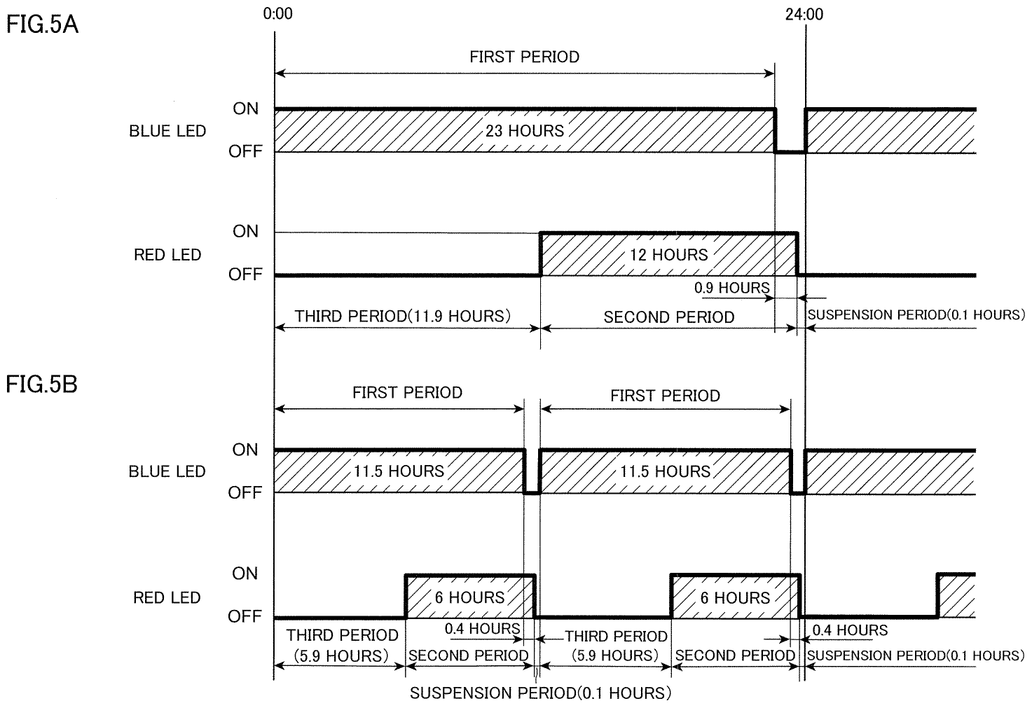

FIGS. 4A, 4B, 5A and 5B are diagrams each showing an example of periods of the blue light irradiation from the blue LEDs and the red light irradiation from the red LEDs related to the exemplary embodiment.

As shown in FIG. 4A, the first period is set at 24 hours, the second period is set at 12 hours and the third period is set at 12 hours as an example. Moreover, as shown in FIG. 4B, the first period is set at 21 hours, the second period is set at 18 hours and the third period is set at 6 hours as another example.

Moreover, if the blue light irradiation is performed 5 hours or more without performing the red light irradiation, during the second period in which the red light irradiation is performed from the red LEDs, the blue light irradiation may be performed or may not be performed. For example, as shown in FIG. 4B, three hours in 18 hours of the second period may serve as a period not performing the blue light irradiation. In such a case, within 24 hours in a day, 15 hours are set for the period in which both the blue light irradiation and the red light irradiation are performed, 6 hours are set for the period in which only the blue light irradiation is performed, and 3 hours are set for the period in which only the red light irradiation is performed. Note that, in the case where the second period is longer than 15 hours and the difference between the first period and the second period is shorter than 5 hours, the period for performing only the red light irradiation is required to secure the blue light irradiation without performing the red light irradiation 5 hours or more.

Moreover, within 24 hours in a day, a period in which neither the blue light irradiation nor the red light irradiation is performed may be provided. For example, as shown in FIG. 5A, it may be possible that the first period, the second period and the third period are set at 23 hours, 12 hours and 11.9 hours, respectively, and 0.9 hours in 12 hours of the second period serve as a period for not performing the blue light irradiation and 0.1 hours serve as a suspension period.

Moreover, the first period, the second period, the third period and the suspension period do not have to be consecutive. Each of the periods may be divided into several times. For example, as shown in FIG. 5B, the first period, the second period and the third period are set at 23 hours, 12 hours and 11.8 hours, respectively, and 0.8 hours in 12 hours of the second period serve as the period for not performing the blue light irradiation and 0.2 hours serve as the suspension period. Then, a cycle of 12 hours in which the first period, the second period and the third period are set at 11.5 hours, 6 hours and 5.9 hours, respectively, and 0.4 hours in 6 hours of the second period serve as the period for not performing the blue light irradiation and 0.1 hours serve as the suspension period is performed two times a day.

Due to the above-described control by the controller 10, the first period for performing the blue light irradiation from the blue LEDs of the LED lamp 60 is as long as 21 hours or more, and the third period for performing the blue light irradiation while not performing the red light irradiation is 5 hours or more; therefore, the upper sides of the leaves can get sufficient blue light, and it is possible to prevent the leaves from curling. Moreover, since the second period for performing the red light irradiation from the red LEDs is 12 hours or more, growth of the plants can be promoted. As a result, according to the present invention, it is possible to promote the growth of the plants while preventing leaves thereof from curling.

### Experimental Results

A description will be given of experimental results of comparison among the case of growing plants by use of the plant cultivation device 1 of the exemplary embodiment (hereinafter, referred to as the “exemplary embodiment” in some cases), the case of growing plants by use of a plant cultivation device related to Comparative example 1 (hereinafter, referred to as “Comparative example 1” in some cases), and the case of growing plants by use of a plant cultivation device related to Comparative example 2 (hereinafter, referred to as “Comparative example 2” in some cases). Among the exemplary embodiment, Comparative example 1 and Comparative example 2, the modes of irradiating the plants with light are different. Note that the growth object is a leaf lettuce, and the breed thereof is Starfighter (produced by Takada Seed Co., Ltd.) In addition, all of the cultivation periods are same.

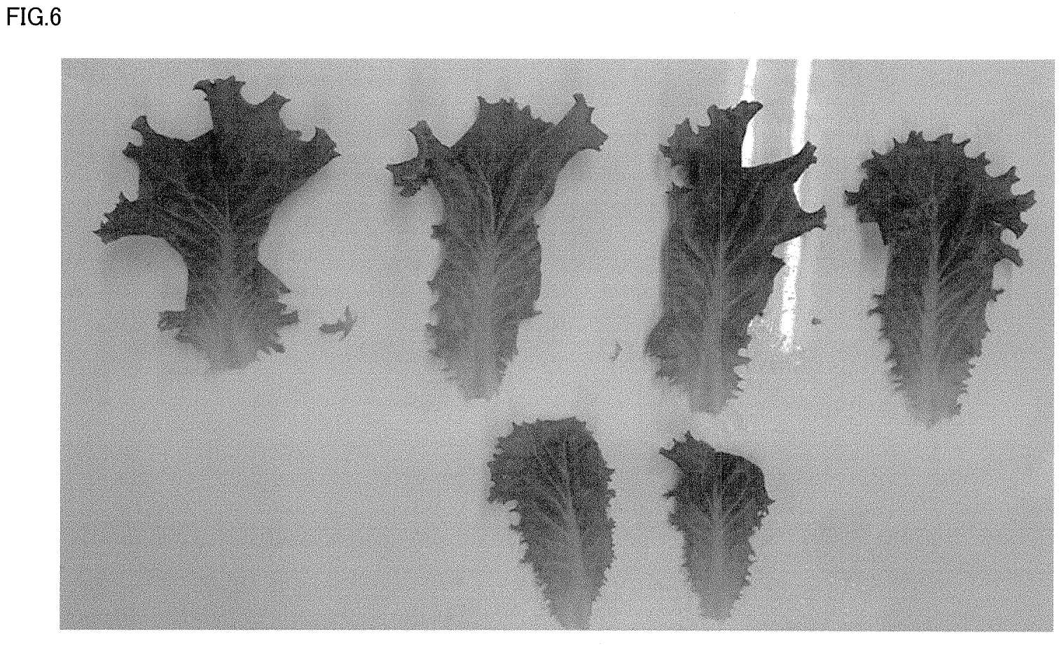

FIG. 6 is a photograph of leaves of leaf lettuces grown by use of the plant cultivation device 1 of the exemplary embodiment.

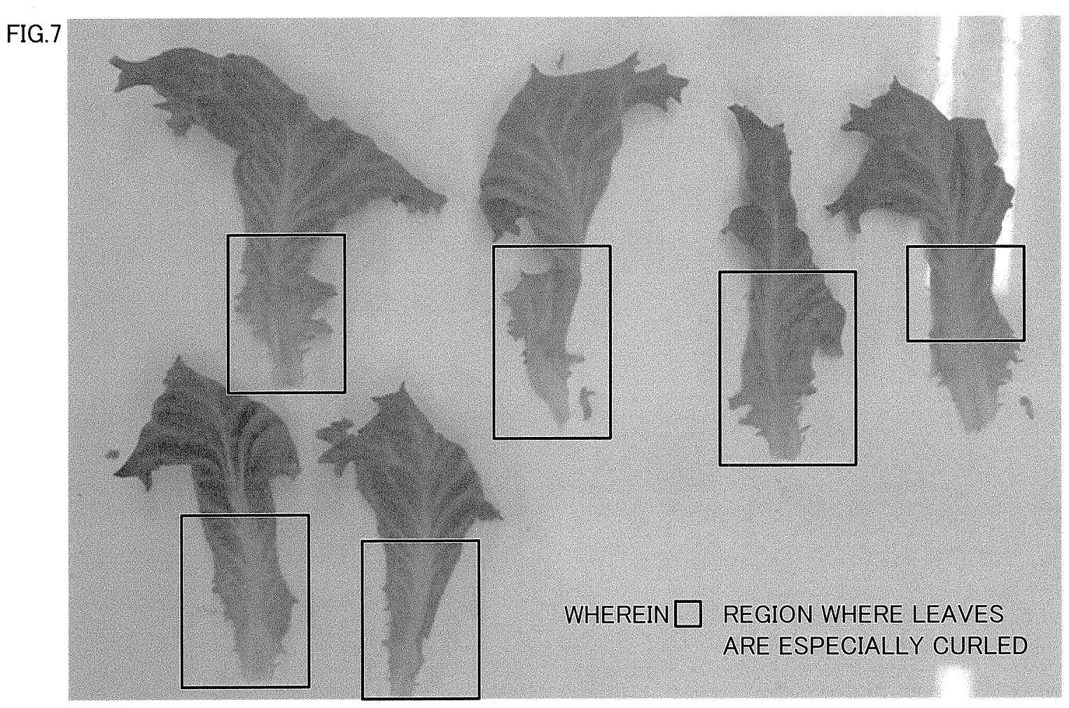

FIG. 7 is a photograph of leaves of leaf lettuces grown by use of the plant cultivation device related to Comparative example 1.

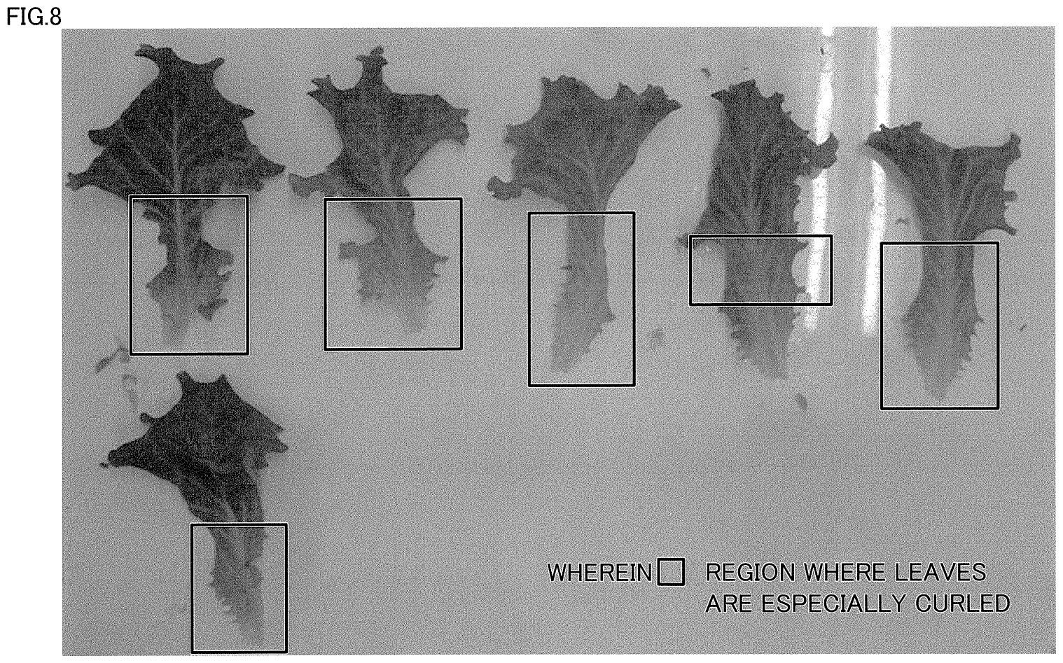

FIG. 8 is a photograph of leaves of leaf lettuces grown by use of the plant cultivation device related to Comparative example 2.

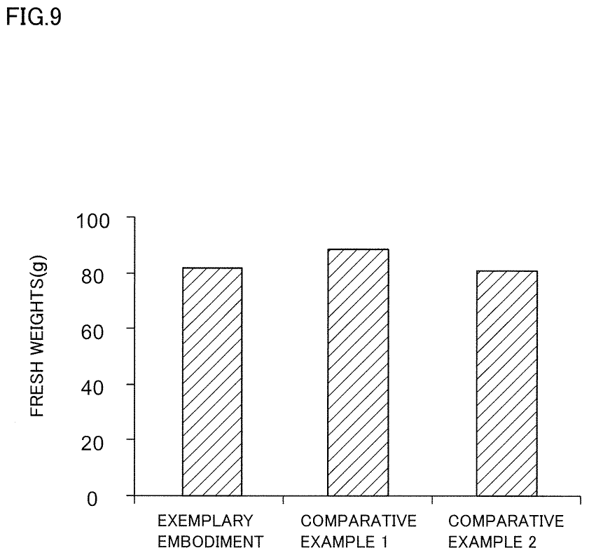

FIG. 9 is a diagram showing a result of comparing above-ground fresh weights (g).

The irradiation conditions in the plant cultivation device 1 of the exemplary embodiment are as follows, as an example.

The above-described first period, second period and third period were, as shown in FIG. 4A, set at 24 hours, 12 hours, and 12 hours, respectively. Moreover, the wavelength of the blue light emitted from the blue LEDs was set at 450 nm and the wavelength of the red light emitted from the red LEDs was set at 660 nm. In addition, the light quantity of the blue light emitted from the blue LEDs was set at 110 mmol/(m²·s) and the light quantity of the red light emitted from the red LEDs was set at 264 mmol/(m²·s). Moreover, the quantity of optical radiation energy per unit area per day was set at 20.9 mol/(m²·d).

On the other hand, the irradiation conditions in the plant cultivation device related to Comparative example 1 are as follows. In a day, the period of consecutive 3 hours was provided for performing the blue light irradiation from the blue LEDs while not performing the red light irradiation from the red LEDs, and the period of consecutive 21 hours was for performing the red light irradiation from the red LEDs while not performing the blue light irradiation from the blue LEDs. Note that the light quantities of the blue light and the red light and the quantity of the optical radiation energy per unit area per day were set to be the same as those of the irradiation conditions in the plant cultivation device 1 of the exemplary embodiment.

The irradiation conditions in the plant cultivation device related to Comparative example 2 are as follows. Instead of the LED lamp 60, an LED lamp including white LEDs was used to emit white light from the white LEDs 24 hours a day. Irradiation of the blue light and the red light was not performed. The light quantity of the white light was set at 242 mmol/(m²·s). Moreover, the quantity of the optical radiation energy per unit area per day was set to be the same as that of the irradiation conditions in the plant cultivation device 1 of the exemplary embodiment.

In all of the plant cultivation device 1 of the exemplary embodiment, the plant cultivation devices related to Comparative example 1 and Comparative example 2, the set temperature in each device and the water temperature in the pool 9 were set at 23° C. and 19° C., respectively.

As shown in the photographs in FIGS. 6, 7 and 8, the leaves of the leaf lettuces grown by use of the plant cultivation device 1 are not curled as compared to the leaves of the leaf lettuces grown by use of the plant cultivation devices related to Comparative example 1 and Comparative example 2.

FIG. 9 shows a result of comparing above-ground fresh weights (g).

As shown in FIG. 9, the above-ground fresh weight of the leaf lettuces grown by use of the plant cultivation device 1 is smaller than the above-ground fresh weight of the leaf lettuces grown by use of the plant cultivation device related to Comparative example 1, but has no significant difference from the above-ground fresh weight of the leaf lettuces grown by use of the plant cultivation device related to Comparative example 2.

From the above experimental results, it was shown that the leaf lettuces grown by use of the exemplary embodiment, in which the irradiation time of the blue light was longer, grew somewhat slower than the leaf lettuces grown by use of Comparative example 1, but the leaves thereof were prevented from curling.

Moreover, it was shown that there was no significant difference in the growth rate between the leaf lettuces grown by use of the exemplary embodiment and the leaf lettuces grown by use of Comparative example 2; however, leaves of the leaf lettuces grown by use of the exemplary embodiment were not curled as compared to the leaves of the leaf lettuces grown by use of the plant cultivation device related to Comparative example 2.

As described above, the plant cultivation device 1 includes: blue LEDs as an example of a first illumination irradiating plants to be cultivated with blue light; red LEDs as an example of a second illumination irradiating the plants with red light; and a controller 10 controlling blue light irradiation from the blue LEDs and red light irradiation from the red LEDs. The controller 10 performs the blue light irradiation 21 hours or more a day, the red light irradiation 12 hours or more a day, and provides a period of performing the blue light irradiation while not performing the red light irradiation 5 hours or more a day. In other words, the controller 10 controls the blue light irradiation to be performed 21 hours or more a day and the red light irradiation to be performed 12 hours or more a day including the case in which the blue light irradiation is performed without performing the red light irradiation 5 hours or more. This makes it possible to grow the plants while preventing leaves thereof from curling without seriously reducing the growth rate of the plants.

Here, to suppress curling of the leaves by prolonging the irradiation time of the blue light, it is preferable to set the irradiation time of the blue light at 23 hours or more a day, and most preferable to set the irradiation time of the blue light at 24 hours a day.

Moreover, to increase the growth rate of the plants, it is preferable to set the irradiation time of the red light at 12 hours or more a day. On the other hand, to suppress curling of the leaves, it is preferable to provide the period in which the blue light irradiation is performed while the red light irradiation is not performed 5 hours or more a day. This is because the leaves are curled to the same extent as the leaves shown in FIG. 7 when the period of performing the blue light irradiation and not performing the red light irradiation is less than 5 hours, whereas the leaves are not curled to the same extent as the leaves shown in FIG. 6 when the period is 6 hours or 9 hours.

Moreover, in the plant cultivation device 1, it is preferable that the blue LEDs are provided to emit light from above the plants. Consequently, for example, as compared to a configuration in which the blue LEDs irradiate the plants from below, the upper sides of leaves of the plants can get more blue light; therefore, the leaves are not curled.

Moreover, the plant cultivation device 1 further includes the housing 3 containing the blue LEDs, the red LEDs and the plants, and portions in the housing 3 facing the growth regions S1 as an example of a region where the plant is grown preferably reflect the blue light and the red light. This makes it possible to promote the growth of the plants.

Moreover, as described above, the method for cultivating a plant by use of the plant cultivation device 1 includes: a step of performing blue light irradiation on a plant to be cultivated 21 hours or more a day including a case in which the blue light irradiation is performed 5 hours or more without performing red light irradiation; and a step of performing red light irradiation on the plant 12 hours or more a day. According to the above-described method, it is possible to grow the plant while preventing leaves thereof from curling without seriously reducing the growth rate of the plant.

Note that, in the above-described exemplary embodiment, the light irradiator 6 may use, for example, other than the above-described LED lamp 60, a fluorescent lamp, an LD (Laser Diode) lamp, or the like. Note that, as compared to the LED, the fluorescent lamp consumes larger amount of electric power and generates larger amount of heat; therefore, the urethane 22 in the cultivation panel 20 or seedlings tend to dry. Consequently, it is preferable to use the LED lamp 60 as the light irradiator 6.

For the leaf vegetables, such as the lettuces, effects of growing plants while preventing leaves thereof from curling without seriously reducing the growth rate of the plants, which are achieved by application of the plant cultivation device 1 and the method for cultivating a plant by use of the plant cultivation device 1 as described above, can be expected. Of the lettuces, the breeds to which the device and the method are especially effective are leaf lettuces or endives, which are lettuces do not form heads; examples of breeds of the leaf lettuces can include Frill Ice (an example of ruffle lettuce) produced by SNOW BRAND SEED Co., Ltd., Starfighter (an example of batavia lettuce), produced by Takada Seed Co., Ltd. (Rijk Zwaan), Green Stage produced by SUMIKA AGROTECH CO., LTD., Mother Green produced by TAKII & CO., LTD., and similar articles thereof. The inventors of the present invention obtained findings that, in these breeds, leaves were likely to be curled by using, for example, the plant cultivation method described in International Publication No. WO 2013/021952 or a plant cultivation method using the plant cultivation device related to Comparative example 1, in other words, a high-speed cultivation method, as compared to the cases of using other methods. The plant cultivation device 1 and the method for cultivating a plant by use of the plant cultivation device 1 are an invention made to solve the problem, and according to the device and the method, it is possible to grow plants while preventing leaves thereof from curling without seriously reducing the growth rate of the plants.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The exemplary embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A plant cultivation device comprising:
a first illumination irradiating a plant to be cultivated with blue light;
a second illumination irradiating the plant with red light; and
a controller controlling irradiation of the blue light from the first illumination and irradiation of the red light from the second illumination, wherein
the controller controls the blue light irradiation to be performed 21 hours or more a day including a case in which the blue light irradiation is performed 5 hours or more without performing the red light irradiation, and the red light irradiation to be performed 12 hours or more a day.

2. The plant cultivation device according to claim 1, wherein the controller performs the blue light irradiation 23 hours or more a day.

3. The plant cultivation device according to claim 1, wherein the controller performs the blue light irradiation 24 hours a day.

4. The plant cultivation device according to claim 1, wherein the plant is a leaf lettuce not forming a head.

5. The plant cultivation device according to claim 1, wherein the first illumination is provided to irradiate the plant with light from above the plant.

6. The plant cultivation device according to claim 5, further comprising:
a housing containing the first illumination, the second illumination and the plant, wherein
a portion in the housing facing a region where the plant is grown reflects the blue light and the red light.

7. A method for cultivating a plant, comprising:
performing blue light irradiation on a plant to be cultivated 21 hours or more a day including a case in which the blue light irradiation is performed 5 hours or more without performing red light irradiation; and
performing the red light irradiation on the plant 12 hours or more a day.
